(19) United States
(12) Patent Application Publication
(10) Pub. No.: US 2026/0159158 A1
(43) Pub. Date: Jun. 11, 2026

(54) METHODS AND APPARATUS FOR OPERATING A VEHICLE

(71) Applicant: Ford Global Technologies, LLC, Dearborn, MI (US)

(72) Inventors: Florian Rath, Pulheim (DE); Simon Baales, Köln (DE); Alexander Hoerdemann, Aachen (DE); Uwe Hoffmann, Leverkusen (DE); Alexander Ein Waldt, Köln (DE); Felix Weinreich, Dortmund (DE)

(21) Appl. No.: 19/409,268

(22) Filed: Dec. 4, 2025

(30) Foreign Application Priority Data
Dec. 6, 2024 (DE) 102024136546.3

(51) Int. Cl. B62D 6/04; G07C 5/08

(52) U.S. Cl. CPC B62D 6/04; G07C 5/0816

(57) ABSTRACT

The disclosure relates in general to vehicles and, more particularly to, methods and apparatus for operating a vehicle. An example vehicle comprising a surroundings sensor to provide first data, and a controller configured to detect a position of a roadway irregularity using the first data, determine that an intended road wheel trajectory of at least one road wheel of the vehicle matches the position of the roadway irregularity, and determine an updated wheel trajectory for the at least one road wheel based on the position of the roadway irregularity.

### RELATED APPLICATION

This patent claims priority from DE Patent Application Number 102024136546.3, which was filed on Dec. 6, 2024, and is hereby incorporated by reference in its entirety.

### FIELD OF THE DISCLOSURE

The disclosure relates in general to vehicles and, more particularly to, methods and apparatus for operating a vehicle.

### BACKGROUND

Some modern vehicle steering systems include semi-autonomous or fully autonomous driving capabilities. Such capabilities at least partially account for traffic signals, pedestrians, other vehicles, etc. while steering the vehicle.

### SUMMARY

An example vehicle comprising a surroundings sensor to provide first data, and a controller configured to detect a position of a roadway irregularity using the first data, determine that an intended road wheel trajectory of at least one road wheel of the vehicle matches the position of the roadway irregularity, and determine an updated wheel trajectory for the at least one road wheel based on the position of the roadway irregularity.

An example non-transitory machine readable storage medium comprising instructions which cause programmable circuitry to detect a position of a roadway irregularity using first data from a surroundings sensor of a vehicle, determine that an intended road wheel trajectory of at least one road wheel of the vehicle matches the position of the roadway irregularity, and determine an updated wheel trajectory for the at least one road wheel based on the position of the roadway irregularity.

An example method comprising detecting a position of a roadway irregularity using first data from a surroundings sensor of a vehicle, determining that an intended road wheel trajectory of at least one road wheel of the vehicle matches the position of the roadway irregularity, and determining an updated wheel trajectory for the at least one road wheel based on the position of the roadway irregularity.

### BRIEF DESCRIPTION OF THE DRAWINGS

FIG. 1 shows a simplified schematic representation of a vehicle with an assembly constructed in accordance with the teachings herein.

FIG. 2 is a flowchart representative of example machine readable instructions and/or example operations that may be executed, instantiated, and/or performed by example programmable circuitry to implement the assembly of FIG. 1.

FIG. 3 is a block diagram of an example processing platform including programmable circuitry structured to execute, instantiate, and/or perform the example machine readable instructions and/or perform the example operations of FIG. 2 to implement the assembly of FIG. 1.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Electromechanical steering systems are a steering technology where a direct mechanical connection between the steering wheel and the road wheel is eliminated. This direct connection is replaced by two actuators, a hand wheel actuator with feedback, and a road wheel actuator. The hand wheel actuator generates a feedback torque for the driver at the steering wheel, and the road wheel actuator controls at least one road wheel(s) into the desired position. The feedback torque imparts a feeling to the driver about the lateral guidance of the vehicle.

In addition, vehicles nowadays have advanced functions, for example advanced driving assistance systems, via which the path of the vehicle is semi-autonomously or fully autonomously independently controlled in a closed loop. For such vehicles, the driver of the vehicle has at least two options for how the driver can interact with the driving assistance system.

In some examples, the driver can completely deactivate the driving assistance system, for example, via a switch, by actuating the speed reduction pedal (e.g., brake pedal), or by applying a torque to the steering wheel that is greater than a specified torque threshold value, such that complete control of the steering can be returned to the driver. In some examples, the driver can apply a desired steering wheel angle to bring about a temporary disabling of the angular target for the steering wheel, which is defined by a path-following function. As soon as the driver releases the steering wheel, the vehicle once again follows the external angle input defined by the driving assistance system, which implements the path-following function. The option of influencing the lateral guidance of the vehicle without terminating it entirely is generally referred to as collaborative closed-loop control. The driving comfort can be reduced for the driver due to the surface condition of the roadway surface, for example, when the roadway surface has potholes or bumps.

Previous approaches describe a pothole assistant for the transverse guidance of a vehicle with a surroundings sensor system and steering which is controllable in a closed loop. Via the surroundings sensor system, the roadway surface is measured ahead of the vehicle in the direction of travel. Based on the measured data from the surroundings sensor system, a pothole present in the roadway surface is detected. An evasion trajectory is determined, which prevents road wheel contact with the detected pothole. According to the evasion trajectory, a steering recommendation is determined, which is applied to the electromechanical steering. This limits the selection of the detectable irregularities in the surface, however, because only potholes are detected. In addition, the evasion trajectory is merely applied, such that the actual evasion of the detected potholes depends on the functionality of the steering system.

Other known solutions describe a system for the closed-loop control of a steering system of a vehicle. The system has at least one detection unit arranged on the vehicle and configured for anticipatorily detecting at least one surface condition of a surface section located ahead of the vehicle in the direction of vehicle travel and subsequently driven on by the vehicle. A data processing unit is configured to generate actuating signals for the closed-loop control of an actuator of the steering system while taking the surface condition into account. The system does not enable going around individual road events such as bumps and potholes, however.

Examples disclosed herein eliminate or at least reduce the disadvantages of the known solutions described above. According to one aspect, some examples of the disclosure relate to a method for operating an assembly of a vehicle. The assembly includes at least one electromechanical steering system, a surroundings sensor, and a closed-loop control device (e.g., electronic control unit (ECU)) coupled to the electromechanical steering system and the surroundings sensor. The method includes at least the following operations. First, the method includes detecting at least one roadway irregularity, for which a position of the roadway irregularity matches at least one intended road wheel trajectory of a road wheel of the vehicle, using the surroundings sensor. Second, the method includes determining adapted wheel trajectories for the road wheels of the vehicle via the closed-loop control device on the basis of the detected roadway irregularity such that the adapted wheel trajectories diverge from the position of the roadway irregularity. The method further includes controlling the electromechanical steering system in a closed loop via the closed-loop control device such that the road wheels follow the respective adapted wheel trajectories.

The method is based on the knowledge that not only do potholes reduce the comfort for the driver of the vehicle, but rather more generally so do different types of irregularities in the surface. A surroundings sensor is therefore used that can detect different irregularities in the surface. If the positions of the detected roadway irregularities match one of the originally intended wheel trajectories, wheel trajectories are adapted to prevent interactions. To enable the interactions to be ruled out, the electromechanical steering system is controlled in a closed loop in a corresponding manner. Examples described herein enable a high level of driving comfort for a plurality of different types of roadway irregularities and which, in addition, also provide specific measures for preventing the interactions. In addition to increasing the driving comfort, the service life of the components and of the vehicle is also lengthened overall as result, because the vehicle is less exposed to external abrupt actions of force.

According to a further aspect, some examples of the disclosure relate to an assembly for a vehicle. The assembly includes at least one electromechanical steering system, a surroundings sensor, and a closed-loop control device coupled to the electromechanical steering system and the surroundings sensor. The surroundings sensor is configured to detect at least one roadway irregularity, for which a position of the roadway irregularity matches at least one intended wheel trajectory of a road wheel of the vehicle. The closed-loop control device is configured to determine adapted wheel trajectories for the road wheels of the vehicle based on the detected roadway irregularity such that the adapted wheel trajectories diverge from the position of the roadway irregularity, and control the electromechanical steering system in a closed loop such that the road wheels follow the respective adapted wheel trajectories. The advantages achieved via the method described herein are also achieved in a corresponding manner via the assembly.

The closed-loop control device can be configured as a dedicated closed-loop control device of the assembly. Alternatively, the closed-loop control device can also be a closed-loop control device of the electromechanical steering system and additionally implement the functionalities described here. As a result, it can be ensured that multiple different closed-loop control devices do not need to be provided. Rather, the closed-loop control device of the electromechanical steering system can implement the functions of the method described here, for example, via software adaptations.

Moreover, the vehicle in some examples includes a vehicle closed-loop driving control device, which includes an advanced driving assistance system. Using the driving assistance system, a path-following function can be implemented. The path-following function controls the lateral guidance of the vehicle in a closed loop in a semi-autonomous or autonomous manner. The guidance of the vehicle is implemented in such a way that a destination that has been predefined by the driver or is self-determined is reached. Typically, the path-following function makes use of surroundings data and/or position data and/or vehicle data which are collected by surrounding sensors and/or a speed sensor and/or a speed change sensor of the vehicle, or via a position signal receiver. This enables the path-following function to steer the vehicle, for example, according to the course of the road and adapt the lateral guidance of the vehicle.

On the basis of the path-following function, a target angle therefore results for each closed-loop control interval, according to which target angle the steering wheel of the vehicle is to be controlled in a closed loop so that the vehicle follows the intended vehicle trajectory determined by the path-following function. Alternatively, the target angle can also relate to an angle input for steerable road wheels of the vehicle, which the road wheels are intended to follow according to respective wheel trajectories so that the vehicle overall follows the intended vehicle trajectory. The closed-loop control device and the vehicle closed-loop driving control device can also be combined in a single closed-loop control device.

The surroundings sensor can include at least one of a camera, a radar, a LIDAR, and an infrared sensor. The surroundings sensor is, in particular, configured to detect the surroundings of the vehicle with respect to arranged objects, persons, further vehicles, and a course of the road. The surroundings sensor transmits the collected surroundings data to the closed-loop control device.

In some examples, the closed-loop control device is configured to determine a course of the road in the direction of movement of the vehicle based on the surroundings data that the closed-loop control device receives from the surroundings sensor. As a result, the closed-loop control device can in some examples determine an intended vehicle trajectory of the vehicle. In the case of the intended vehicle trajectory of the vehicle, the closed-loop control device can also consider a steering wheel angle and/or a steering wheel speed of the steering wheel relative to a reference position or a reference value. As described below, the corresponding parameters of the steering wheel can be detected using a steering wheel sensor.

Alternatively or additionally, the closed-loop control device can take a path-following function of an advanced driving assistance system into account. This means that the closed-loop control device therefore determines the direction in which and the speed with which the vehicle is expected to move for a specified interval or for a specified distance. In a further alternative, the closed-loop control device of the assembly can also receive the intended vehicle trajectory from the vehicle closed-loop driving control device that includes the driving assistance system. Ultimately, an intended vehicle trajectory is therefore determinable or receivable by the closed-loop control device. The road wheels of the vehicle then follow intended wheel trajectories, so that the vehicle overall can follow the intended vehicle trajectory.

The electromechanical steering system can in particular be understood to be a steer-by-wire (SBW) steering system. The electromechanical steering system of the vehicle is to be understood here as a conventional electromechanical steering system of the vehicle and not an auxiliary steering system, which is only made possible via a closed-loop torque control with respect to drive units (e.g., motors) and/or deceleration devices (e.g., wheel brakes) which are associated with respective road wheels (e.g., not a tertiary lateral control (TLC)). In this context, the drive units are understood to be correspondingly operated electric motors, each of which is associated with at least one road wheel and are used to propel the vehicle. They are not used primarily for the lateral guidance of the vehicle. Rather, the drive units of the TLC are separate from the road wheel actuators and their electric motors.

The electromechanical steering system includes at least one road wheel actuator, which is coupled to at least one steerable road wheel. In some examples, the road wheel actuator can also be simultaneously coupled at least indirectly to multiple steerable road wheels, for example, via a toothed rack. Alternatively or additionally, the vehicle can have multiple road wheel actuators, each of which is individually coupled to multiple steerable road wheels. According to a further alternative, the vehicle can have, also with respect to at least some steerable road wheels of the vehicle, separate individual road wheel actuators. As a result, the corresponding steerable road wheels can be controlled in a closed loop independently of other steerable road wheels for the lateral guidance of the vehicle according to individual wheel orientations. This makes it possible, for example, for individual steerable road wheels to have different orientations, for example a toe-in position or a toe-out position which is defined by the steering wheel angle of the steering wheel. This means that the corresponding steerable road wheels intentionally diverge from the toe position that corresponds to the steering input of the driver and/or a path-following function of the driving assistance system. This can be advantageous, for example, when individual road wheels of the vehicle have a high longitudinal slip and/or slip angle, for example, due to the condition of the ground (e.g., during off-road driving).

The toe-in position or the toe-out position is to be understood in this context to mean that the steerable road wheel assumes an orientation with respect to the wheel steering axis of the steerable road wheels such that it intentionally diverges from a toe position of the vehicle. In general, toe-in positions and toe-out positions are defined only with respect to a straight-ahead position of the steerable road wheels. In this context, the toe-in positions and toe-out positions explained here are intentionally divergent positions of the steerable road wheels that are also applied during a steering process. The toe position of the vehicle corresponds to an orientation of the steerable road wheels corresponding to the steering input. The toe position indicates the direction in which the driver would like to steer the vehicle. Using the toe-in position, the steerable road wheel on the outside of the curve artificially deviates from this orientation, specifically corresponding to a steering angle that is greater than desired according to the steering input. Correspondingly, the steerable road wheel on the outside of the curve also artificially deviates from this orientation using the toe-out position, specifically corresponding to a steering angle that is smaller than desired according to the steering input. If, for example, the toe position corresponding to the steering input indicated a straight-ahead orientation of the vehicle along the vehicle longitudinal axis, the steerable road wheel would be rotated, according to the toe-in position or the toe-out position, at least partially about the wheel steering axis of the respective road wheel and would have an orientation that diverges from the straight-ahead orientation. The toe-in position and the toe-out position correspond to orientations on opposite sides of the reference direction, which is defined by the toe position based on the steering input.

In some examples, the lateral guidance of the vehicle can be at least partially based on steering inputs of the driver, which the driver affects, for example, using the steering wheel, to steer the vehicle in a specific direction.

As mentioned above, the lateral guidance of the vehicle can also be based, alternatively or additionally, on the path-following function, of course, which is implemented by the vehicle closed-loop driving control device within the framework of a driving assistance system. Alternatively or additionally, further comfort functions can also be implemented by the path-following function, for example, a lane keeping assist system or the like. The additional comfort functions can also influence the lateral guidance of the vehicle, for example, to prevent the vehicle from unintentionally changing lanes.

The hand wheel actuator is configured to apply a torque to the steering wheel at least indirectly, for example, via a steering column coupled to the steering wheel. The torque brought about by the hand wheel actuator is also used to provide the driver with torque feedback on the lateral guidance of the vehicle. In general, the hand wheel actuator has an electric motor to be able to apply the torque to the steering wheel. The electric motor can have, for example, a winding set with three windings (e.g., a three-phase winding set). Alternatively, the electric motor can also have more winding sets.

A steering wheel sensor of the electromechanical steering system is configured to detect a steering wheel angle with respect to a reference position, for example a zero position (e.g., corresponding to a straight-ahead orientation). Alternatively or additionally, the steering wheel sensor can also be configured to detect a steering wheel speed during the rotation. The steering wheel sensor transmits the collected measured data to the closed-loop control device. The steering wheel sensor can be directly coupled to the steering wheel; alternatively, however, it can also be coupled to the steering column, because the steering column is rigidly coupled to the steering wheel and a rotation of the steering wheel is therefore directly converted into a rotation of the steering column.

A wheel sensor of the electromechanical steering system is associated with at least one road wheel of the vehicle and configured to individually detect a rotational speed of the associated road wheel in the circumferential direction (e.g., a rolling direction). Based on the detected rotational speeds, for example, the longitudinal slip of individual wheels can be determined by the closed-loop control device. The wheel longitudinal slip refers to the divergence of the wheel running surface according to the wheel speed from the roadway surface with which the respective wheel has (e.g., or should have) frictional contact, wherein a tangentially acting force counteracts the traction. Traction means the transmission of the tensile force for propelling the vehicle on the road surface. A certain degree of wheel longitudinal slip typically occurs during the propulsion of the vehicle, for example, depending on the condition of the road surface and the tire type. If the wheel longitudinal slip becomes too great, however, the vehicle can no longer be guided precisely or even adequately.

Due to the determination of the longitudinal slip of individual wheels, the vehicle state of the vehicle can be precisely characterized via the closed-loop control device. For example, the vehicle can also be characterized with respect to its speed-change values at a specific point in time. Additionally or alternatively, the electromechanical steering system can have a toothed rack sensor, which is configured to detect a toothed rack force acting on a toothed rack via a road wheel actuator. In such example, the steerable road wheels are coupled to the toothed rack. These parameters, for example the longitudinal slip of individual wheels and the toothed rack force, are then considered by the closed-loop control device when determining the relevant feedback torque that is to be applied to the steering wheel by the hand wheel actuator to impart a feeling to the driver of the vehicle about the lateral guidance of the vehicle.

Roadway irregularities that do not match an intended wheel trajectory of a road wheel can also be detected by the surroundings sensor. This means that the corresponding roadway irregularities have positions such that no interaction (e.g., contact) with at least one intended wheel trajectory of the vehicle occurs, at least provided the vehicle follows the intended wheel trajectories. As such, the method, in some examples, relates to such roadway irregularities, with respect to which the closed-loop control device can assume that interactions with at least one intended wheel trajectory of the vehicle occur, if the vehicle follows the intended wheel trajectories. If such a corresponding roadway irregularity is detected, for which an interaction cannot be ruled out, wheel trajectories adapted according to the method are determined to prevent an interaction. In such examples, the adapted wheel trajectories have a course that does not coincide with the position of the corresponding roadway irregularity. The adapted wheel trajectories deviate from the position of the detected roadway irregularity. Thus, an interaction of the roadway irregularity with the road wheels of the vehicle can be ruled out. Provided the vehicle follows the adapted wheel trajectories, the situation in which an action of force is exerted upon the vehicle due to the roadway irregularity can therefore be prevented.

In some examples, the roadway irregularity can include at least one of a bump, a pothole, a curb, an object arranged on the roadway, or the like. The roadway irregularity can have either a negative height or a positive height with respect to a height profile of a part of the roadway surrounding the roadway irregularity. The roadway irregularity is, in such examples, a structure which, when traversed by the road wheels of the vehicle, would result in an abrupt action of force on the vehicle. Decisively, the action of force is caused by the height profile of the roadway irregularity.

In some examples, the closed-loop control device takes extents or dimensions of the detected roadway irregularity into account when determining the adapted wheel trajectories. This means that the adapted wheel trajectories are determined by the closed-loop control device such that they not only diverge from a central position of the roadway irregularity, but rather, where possible, are arranged such that they also extend outside the outer dimensions of the roadway irregularity. Thus, an interaction between the road wheels and the roadway irregularity can be entirely prevented. In some examples, a tolerance distance between a course of the adapted wheel trajectories and the roadway irregularity is considered by the closed-loop control device. As a result, the likelihood of an interaction can be minimized.

If, due to the dimensions of the roadway irregularity or due to further constraints, for example the dimensions of the roadway, adapted wheel trajectories cannot be determined via the closed-loop control device such that an interaction with the roadway irregularity can be ruled out, adapted wheel trajectories are in some examples determined via the closed-loop control device such that the interaction with the detected roadway irregularity is reduced or minimized. Thus, the action on the vehicle is kept as low as possible in such examples.

In some examples, the closed-loop control device determines at least one adapted road wheel angular pattern for at least one road wheel of the vehicle such that the road wheels follow the respective adapted wheel trajectories. As a result, the closed-loop control device can determine changes in the orientation of the steerable road wheels, for example, due to rotation about the wheel steering axis of the steerable road wheels, so that the vehicle overall is guided such that the road wheels follow the adapted wheel trajectories. Because, in this electromechanical steering system, the direct mechanical coupling between the steering wheel and the steerable road wheels is eliminated, the guidance of the vehicle according to the adapted wheel trajectories isolated to an adapted road wheel angular pattern can be ensured. In such examples, the steering wheel does not need to be guided, for example, in an adapted manner, for the road wheels to follow the adapted wheel trajectories. In some examples, the closed-loop control device can also determine adapted road wheel angular patterns for each road wheel of the vehicle. Thus, the precision of the lateral guidance of the vehicle is increased, so that the vehicle is guided such that the road wheels follow the adapted wheel trajectories.

In some examples, the electromechanical steering system has at least one road wheel actuator, which is coupled to at least one steerable road wheel. The closed-loop control device outputs actuating signals to the road wheel actuator in such a way that at least one steerable road wheel of the vehicle is steered to follow the adapted road wheel angular pattern. Thus, it is ensured that the vehicle is also actually guided according to the adapted wheel trajectories.

Because the road wheels of the vehicle are in a fixed distance relationship to the other road wheels of the vehicle, the determination of a single adapted road wheel angular pattern can be sufficient. The remaining adapted road wheel angular patterns arise from the fixed distances between the individual road wheels.

In some examples, the closed-loop control device determines at least one adapted steering wheel angular pattern for at least one steering wheel of the vehicle in such a way that the adapted steering wheel angular pattern is formed to correspond to the adapted wheel trajectories. This makes it possible to also guide the steering wheel in such a way that the steering wheel angle and the steering wheel speed reflect the configuration, according to which the vehicle is guided in such a way that the road wheels follow the adapted wheel trajectories. Although the electromechanical steering systems enable, in principle, a decoupling between the steering wheel guidance and the road wheel guidance, this example results in a more consistent feel for the driver of the vehicle, because the steering wheel is guidable in a manner corresponding to the adapted wheel trajectories. The electromechanical steering system has at least one hand wheel actuator coupled to the steering wheel. The closed-loop control device outputs actuating signals to the hand wheel actuator in such a way that the steering wheel is steered to follow the adapted steering wheel angular pattern. As a result, it is ensured that a torque is applied to the steering wheel by the hand wheel actuator in such a way that the steering wheel angle and/or steering wheel speed reflects the course of the adapted wheel trajectories. In this way, consistent lateral guidance of the vehicle is enabled.

In some examples, the steering wheel is steered by the closed-loop control device according to a collaborative closed-loop control mode, in that an additional driver torque can be applied to the steering wheel by the driver of the vehicle. This means that the electromechanical steering system is configured in such a way that the steering wheel is usable according to a collaborative closed-loop control. In the collaborative closed-loop control mode, a torque for the lateral guidance of the vehicle is applied to the steering wheel by the hand wheel actuator of the electromechanical steering system. The lateral guidance of the vehicle follows the path-following function of the driving assistance system. In addition, in the collaborative closed-loop control mode, the driver of the vehicle can also apply a manual driver torque to the steering wheel. The steering wheel, which is collaboratively guided based on the driving assistance system and the manual driver input, has a resultant steering wheel angle and a resultant steering wheel speed. In this closed-loop control mode, the resultant steering wheel angle and/or the resultant steering wheel speed is detected. Then, the detected parameters are used as manipulated variables for the road wheel actuator for orienting the steerable road wheels of the vehicle. This means that the steering wheel has two different torque application mechanisms, because of which the driver can diverge from the intended vehicle trajectory specified by the driving assistance system using the driver torque.

In some examples, the assembly and the electromechanical steering system can be configured in such a way that, during the collaborative closed-loop control mode, an autonomous application of a torque to the steering wheel has priority over a manual application of a driver torque for carrying out the method. In that respect, by correspondingly controlling the steering wheel in a closed loop via the hand wheel actuator based on an actuating signal which it receives from the closed-loop control device, a torque can be applied to the steering wheel in such a way that an additional manual application of a driver torque is reduced or minimized.

In some examples, an additional manual application of a driver torque can also be prevented in that a torque that is so high that an additional driver torque can be disregarded is applied to the steering wheel by the hand wheel actuator. For example, in the collaborative closed-loop control mode, the autonomous application of a torque to the steering wheel can implement the main control over the position of the steering wheel. As a result, it can be ensured that the vehicle is guided in such a way that the road wheels follow the adapted wheel trajectories. For example, the situation can thus also be prevented in which the driver applies a driver torque which counteracts the adapted wheel trajectories and, due to which, the road wheels would be guided in such a way that an interaction with the detected roadway irregularity would occur.

Due to an additional driver torque, the steering wheel angle of the steering wheel can diverge from the target angle of the path-following functionality. In such examples, a difference between the actual steering wheel angle and the target angle therefore results. In this context, the closed-loop control device in some examples returns the steering wheel back to the target angle via the hand wheel actuator, provided a driver stops applying an additional driver torque to the steering wheel. As a result, a defined transition of the collaborative closed-loop control is created when the manual actuation of the steering wheel is terminated. As a result, the transition between the configuration of a simultaneous manual and autonomous closed-loop control of the steering wheel and the configuration of an exclusively autonomous closed-loop control of the steering wheel is gentle and seamless. In this way, the lateral guidance of the vehicle does not undergo abrupt changes, because of which the comfort for the driver of the vehicle is increased.

In some examples, when the adapted wheel trajectories are determined via the closed-loop control device, at least driving situation-dependent surroundings data from the surroundings sensor are considered. The driving situation-dependent surroundings data in some examples relate to at least one free space, which is usable by the vehicle, in the surroundings of the detected roadway irregularity; other road users, which can have either the same direction of travel or other directions of travel, for example an opposite direction of travel; and regions of the roadway that can be driven on. This means that the surroundings data are evaluated by the closed-loop control device in such a way that the roadway is assessed with respect to the permissibly usable roadway surface when determining the adapted wheel trajectories. Of course, the adapted wheel trajectories are determined in such a way that interactions with other road users are prevented. In some examples, when determining the adapted wheel trajectories, tolerance distances to other road users and/or a roadway boundary are provided. This allows undesired approaches to be prevented.

In some examples, at least one notification is output to a driver of the vehicle regarding the adapted wheel trajectories by the closed-loop control device via at least one user interface. Ultimately, this results in the driver of the vehicle being notified about the influence of the closed-loop control device on the conventional guidance of the vehicle. Thus, the information content for the driver of the vehicle is increased, and they are not surprised when the closed-loop control device initiates autonomous adaptations of the wheel guidance of the road wheels and/or of the steering wheel guidance of the steering wheel of the vehicle. In some examples, the output of the notification is configured to not occur. For example, this can be carried out in response to a user input via a user interface. This allows the driver of the vehicle to continue to direct their attention to the roadway.

According to a further aspect, the disclosure also relates to a computer program product including commands, which, when the program is run on a computer, prompt the computer to carry out the method as described herein. The advantages achieved via the method described herein are also achieved in a corresponding manner via the computer program product. According to an additional aspect, the disclosure also relates to a non-transitory computer-readable storage medium including commands, which, when the program is run on a computer, prompt the computer to carry out the method as described herein. The advantages achieved via the method described herein are also achieved in a corresponding manner via the non-transitory computer-readable storage medium. According to a further aspect, some examples of the disclosure relate to a vehicle with an assembly as described herein or an assembly which is operable according to a method as described herein. The advantages achieved via the method described herein are also achieved in a corresponding manner via the vehicle.

Within the meaning of the disclosure, vehicles can include land vehicles, such as off-road vehicles, passenger cars, busses, trucks, and other utility vehicles. Vehicles can be manned or unmanned. The vehicles are at least partially electrically propelled (e.g., have an electric motor which is used for propulsion). In addition, the vehicles can in some examples also have an internal combustion engine.

All features explained with respect to the different aspects are combinable individually or in (sub-) combination with other aspects. The following detailed description in connection with the accompanying drawings, in which same numbers refer to same elements, is intended to be a description of different examples of the disclosed subject matter and is not intended to represent the individual examples. Each example described in this disclosure is only provided as an example or illustration and should not be interpreted as preferred or advantageous in comparison with other examples. The illustrative examples contained herein make no claim to completeness and do not limit the claimed subject matter to the specific disclosed forms. Different modifications of the described examples are readily apparent for a person skilled in the art, and the general principles defined herein can be applied to other examples and applications without deviating from the spirit and scope of the described examples. The described examples are therefore not limited to the examples shown but rather have the greatest possible area of application that is combinable with the principles and features disclosed here.

All features disclosed in the following with reference to the examples and/or the accompanying figures can be combined alone or in an arbitrary sub combination with features of the aspects of the disclosure, provided the resultant combination of features is meaningful for a person skilled in the art in the technical field.

For the purposes of the disclosure, the wording “at least one of A, B and C” means, for example, (A), (B), (C), (A and B), (A and C), (B and C) or (A, B and C), including all further possible combinations when more than three elements are listed. In other words, the term “at least one of A and B” means, in general, “A and/or B”, namely “A” alone, “B” alone, or “A and B.”

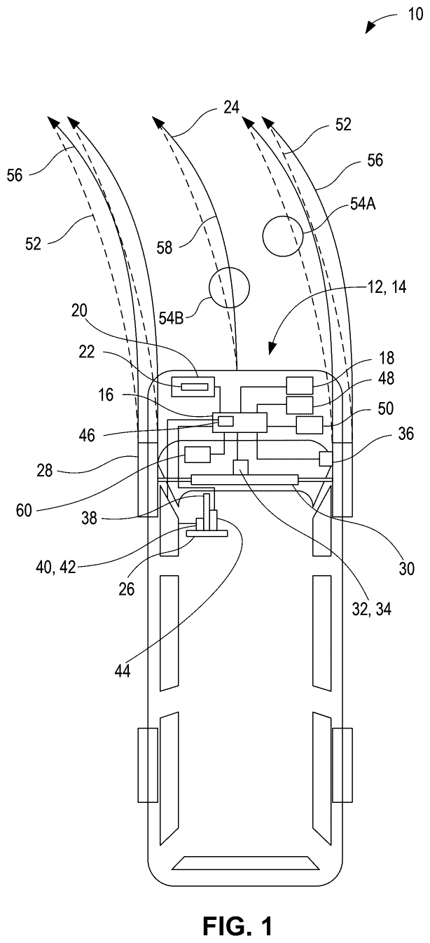

FIG. 1 shows a simplified schematic representation of a vehicle 10 with an assembly 12 according to one example. The assembly 12 includes both an electromechanical steering system 14 of the vehicle 10 and a closed-loop control device 16 and at least one surroundings sensor 18.

The surroundings sensor 18 is configured to collect surroundings data of the surroundings of the vehicle 10. To this end, the surroundings sensor 18 includes at least one of a camera, a radar, a LIDAR, and an infrared sensor. Using the surroundings sensor 18, surroundings data with regard to the course of the road, of road users, of objects, and of roadway irregularities can be collected. The surroundings sensor 18 transmits the correspondingly collected surroundings data to the closed-loop control device 16 of the assembly 12.

According to this example, the vehicle 10 also includes a vehicle closed-loop driving control device 20. Using the vehicle closed-loop driving control device 20, according to this example, an algorithm having a path-following function 22 is implemented within the framework of a driving assistance system. This means that, on the basis of a destination of the vehicle 10 to be reached, a vehicle trajectory 24 for the vehicle 10 is established via the algorithm having the path-following function 22, for example, according to a course of the road, according to which the vehicle 10 is to be steered. The course of the road can be determined based on the surroundings data of the vehicle 10 collected by the surroundings sensor 18. As a result, a target angle for a steering wheel 26 of the electromechanical steering system 14 is established via the algorithm having the path-following function 22. The steering wheel 26 is therefore to be deflected from a reference position according to the target angle, so that a desired lateral guidance of the vehicle 10 is ensured in such a way that the actual trajectory of the vehicle 10 matches the correspondingly determined vehicle trajectory 24.

The vehicle 10 also includes steerable road wheels 28 as part of the electromechanical steering system 14. The steerable road wheels 28, according to this example, are coupled to a common toothed rack 30. The common toothed rack 30 can be moved out of a reference position, for example a zero position, which brings about a steering motion of the steerable road wheels 28. This allows the steerable road wheels 28 to be deflected, for example starting from a straight-ahead orientation of the vehicle 10, so that the vehicle 10 rounds a curve. In some examples, the target angle determined via the algorithm having the path-following function can relate to a wheel angle that is to be assumed by the steerable road wheels 28 and that must be ensured so that the actual trajectory of the vehicle 10 matches the correspondingly determined vehicle trajectory 24.

To move the toothed rack 30, the electromechanical steering system 14 according to this example includes road wheel actuator 32, that can jointly influence the orientation of both steerable road wheels 28 (front wheels) of the vehicle 10. In the illustrated example, the road wheel actuator 32 is coupled to the toothed rack 30. Alternatively, the road wheel actuator 32 can also be coupled to the steerable road wheels 28 in another way to be able to influence their orientation.

In some examples, multiple road wheel actuators 32 can also be provided, each of which is coupled individually to a steerable road wheel 28. This has the advantage that the road wheels 28 are not moved jointly, because of which the road wheels 28 can be oriented individually. For example, individual road wheels 28 can then assume dedicated off-track positions, for example, for specific driving situations (e.g., off-road driving). An off-track position means, in such examples, that the road wheels 28 are then not oriented according to the nominal track position, which is defined by the steering wheel angle of the steering wheel 26.

Even though this is not shown in the example from FIG. 1, the vehicle 10, the assembly 12, and the electromechanical steering system 14 can also include further steerable road wheels 28, for example rear wheels, which are coupled to an additional common wheel actuator or to individual road wheel actuators 32.

Each road wheel actuator 32 includes an electric motor 34. The electric motor 34 includes at least one winding set, which includes a group of windings. Each winding set is configured such that phase currents can be used to drive a rotor of the electric motor 34. The rotor can then be coupled to a corresponding component of the electromechanical steering system 14, for example the toothed rack 30, and thus enable the movement of the steerable road wheels 28. In general, the electric motor 34 can also have more than one winding set. Typically, each winding set is three-phase, such that the electric motor 34 overall is at least three-phase, in some examples also six-phase or nine-phase. If multiple winding sets are present, the winding sets each enable a movement of the rotor of the electric motor 34 independently of other winding sets. This means that the winding sets are separate from one another.

The electromechanical steering system 14 also includes wheel sensors 36, for example rotational speed sensors, based on which the rotational speeds of the road wheels 28 in the circumferential direction (e.g., the rolling direction) can be individually detected. Based on the detected rotational speeds, for example, the individual wheel slip can be determined, which makes it possible to characterize the vehicle 10 according to the driving situation. Typically, one wheel sensor 36 is associated with each road wheel 28.

Using the steering wheel 26, a driver of the vehicle 10 can effect steering inputs for the vehicle 10 to steer the vehicle 10 in a desired direction, for example along the vehicle trajectory 24. The steering wheel 26 is at least indirectly coupled to a steering column 38 of the electromechanical steering system 14. The steering column 38 defines the axis of rotation, about which the steering wheel 26 is rotatable.

A hand wheel actuator 40 of the electromechanical steering system 14 is at least indirectly coupled to the steering wheel 26, according to this example via the steering column 38. The hand wheel actuator 40 has a further electric motor 42. The electric motor 42 of the hand wheel actuator 40 also includes at least one winding set. Each winding set of the electric motor 42 is three-phase and configured to drive a rotor of the electric motor 42. As a result, a torque, for example a feedback torque for the driver, can be provided at the steering wheel 26 of the vehicle 10 by the electric motor 42 to impart a feeling to the driver about the lateral guidance of the vehicle 10 or to autonomously or semi-autonomously ensure the lateral guidance according to the vehicle trajectory 24.

Using the steering wheel of the electromechanical steering system 14, feedback torque can be applied to the steering wheel 26 to impart a feeling to the driver of the vehicle 10 about the lateral guidance of the vehicle 10. The feedback torque can be determined by the closed-loop control device 16 and based on a determined individual wheel slip and/or on a toothed rack force which acts on the toothed rack 30. The individual wheel slip can be determined using the wheel sensors 36.

The electromechanical steering system 14 also includes at least one steering wheel sensor 44, which is coupled to the steering wheel 26 at least indirectly, for example, via the steering column 38. Each steering wheel sensor 44 is configured independently of other steering wheel sensors 44 to detect a steering input of the driver based on a steering wheel angle (rotational angle) and/or based on a steering wheel speed of the steering wheel 26 in comparison to a reference position or a reference value. The steering wheel sensor 44 is shown here as coupled to the steering column 38 because the steering wheel 26 is rigidly coupled to the steering column 38 and a rotation of the steering wheel 26 is therefore converted directly into a rotation of the steering column 38. In general, the steering wheel sensor 44 can of course also be coupled to the steering wheel 26 itself, for example, to a basic component of the steering wheel 26, instead of to the steering column 38. In such examples, the steering wheel sensor 44 can directly detect the rotation of the steering wheel 26 itself.

The closed-loop control device 16 of the assembly 12 includes a data processing device 46. The closed-loop control device 16 of the assembly 12 is also configured, according to this example, as a closed-loop control device 16 of the electromechanical steering system 14. This means that the closed-loop control device 16 takes on the conventional closed-loop control functions of the electromechanical steering system 14. The closed-loop control device 16, according to this example, is coupled at least to the vehicle closed-loop driving control device 20, to the road wheel actuator 32, to the wheel sensor 36, to the hand wheel actuator 40, and to the steering wheel sensor 44. The closed-loop control device 16, according to this example, runs an algorithm for the closed-loop control of the steerable road wheels 28 and an algorithm for setting an appropriate feedback torque at the steering wheel 26. The algorithms can be combined in one single algorithm.

Overall, the electromechanical steering system 14 is configured for the collaborative closed-loop control of the steering wheel 26. This means that a corresponding actuating signal can be output to the hand wheel actuator 40 by the closed-loop control device 16 to autonomously or semi-autonomously apply a torque to the steering wheel 26. At the same time, the steering wheel 26 is released, provided, however, the driver can apply an additional driver torque to the steering wheel 26, with an optional exception in specific operating situations. Both the torque applied by the hand wheel actuator 40 as well as the driver torque applied by the driver result in a steering wheel angle of the steering wheel 26 setting in.

The steering wheel angle and/or a steering wheel speed are detected by the steering wheel sensor 44, which is used by the closed-loop control device 16 to control the steerable road wheels 28 according to the detected parameters. The closed-loop control device 16 outputs a corresponding actuating signal to the road wheel actuator 32, which brings about a torque for orienting the steerable road wheels 28. The torque output by the road wheel actuator 32 can act, for example, on the toothed rack 30, which then brings about the orientation of the steerable road wheels 28.

In an alternative of associating one road wheel actuator 32 with each steerable road wheel 28, a corresponding actuating signal is transmitted from the closed-loop control device 16 to each road wheel actuator 32. In addition, the vehicle 10 according to this example has at least one position signal receiver 48 and a speed and speed-change sensor 50, which are also coupled to the closed-loop control device 16. Via the position signal receiver 48, a position signal of a global navigation satellite system can be received, such that the closed-loop control device 16 can determine the position of the vehicle 10 based on the received position signal. For example, the speed of the vehicle 10 can also be indirectly determined from the position of the vehicle 10. The position of the vehicle 10 can be considered when determining corresponding vehicle trajectories 24 and/or wheel trajectories 52 (e.g., see below).

Using the speed and speed-change sensor 50, the vehicle speed and/or the speed-change values of the vehicle 10 can be precisely detected along three directions oriented orthogonally to one another and transmitted to the closed-loop control device 16. As a result, the driving situation of the vehicle 10 is precisely characterizable via the closed-loop control device 16 at a corresponding point in time of the closed-loop control. In some examples, the closed-loop control device 16 can therefore take further parameters of the vehicle 10, for example, the vehicle speed or speed-change values, into account when outputting the actuating signal to a road wheel actuator 32. In some examples, these values can be considered within the framework of the closed-loop control of the torque which is to be applied to the steering wheel 26 by the hand wheel actuator 40. In addition, the determined vehicle parameters indirectly detected by the position signal receiver 48 and the speed and speed-change sensor 50 can be considered by the vehicle closed-loop driving control device 20 within the framework of the algorithm having the path-following function 22.

In some examples, the electromechanical steering system 14 can include multiple components of the same type and, in general, of the same function, for example, multiple steering wheel sensors 44, as a result of which redundancy is ensured.

In some examples, a vehicle trajectory 24 is determined via the vehicle closed-loop driving control device 20 within the framework of the algorithm having the path-following function 22, according to which vehicle trajectory the vehicle 10 is to be guided to be able to reach a predefined destination. As explained above, the surroundings data collected by the surroundings sensor 18 are also considered when determining the vehicle trajectory 24. Corresponding wheel trajectories 52 correspond to the vehicle trajectory 24. Whereas a reference point of the vehicle 10, for example, a center point or a center of gravity, is (e.g., is to be) therefore moved along according to the vehicle trajectory 24, the road wheels 28 of the vehicle 10 follow the intended wheel trajectories 52 determined by the vehicle closed-loop driving control device 20. If the vehicle closed-loop driving control device 20 takes on the determination of the vehicle trajectory 24 and the intended wheel trajectories 52, the vehicle trajectory 24 and the intended wheel trajectories 52 are transmitted to the closed-loop control device 16.

In a collaborative closed-loop control mode, in which the vehicle closed-loop driving control device 20 does not implement the lateral guidance of the vehicle 10, or in which the lateral guidance of the vehicle 10 can be influenced by the driver on the basis of an additional driver torque which is applied to the steering wheel 26, the vehicle trajectory 24 is, of course, also defined by the driver inputs using the steering wheel 26. In such examples, the closed-loop control device 16 determines the vehicle trajectory 24 and the intended wheel trajectories 52 while considering the driver inputs at the steering wheel 26. As a result, the closed-loop control device 16 can determine which orientations the vehicle 10 and the road wheels 28 of the vehicle 10 will have in the future.

The surroundings sensor 18 can then, in principle, detect roadway irregularities 54. Using the surroundings data which the surroundings sensor 18 collects, the closed-loop control device 16 can determine a position, a height profile, and extents of the roadway irregularities 54A, 54B. The roadway irregularities 54 can include bumps and/or potholes and/or objects. In such example, the closed-loop control device 16 can determine that at least one roadway irregularity 54A has a position such that it at least partially matches (e.g., coincides with) an intended wheel trajectory 52 of a road wheel 28 of the vehicle 10. If the direction of movement of the vehicle 10 is not modified, an interaction (action of force) would therefore occur between the detected roadway irregularity 54A and the vehicle 10. Other detected roadway irregularities 54B are positioned in such a way that their position does not match an intended wheel trajectory 52 of a road wheel 28 of the vehicle 10, such that an influence on the vehicle 10 can be ruled out.

The closed-loop control device 16 is then configured to determine adapted wheel trajectories 56, which are aligned and oriented such that they do not match a position of the corresponding detected roadway irregularity 54A. Because the closed-loop control device 16 additionally takes all detected roadway irregularities 54 into account, the adapted wheel trajectories 56 can, in general, be oriented and positioned in such a way that an interaction with any detected roadway irregularity 54 is prevented. Based on the adapted wheel trajectories 56, an adapted vehicle trajectory 58 is also defined, because the road wheels 28 are arranged on the vehicle 10 in a defined manner. While in the illustrated example, the closed-loop control device 16 is shown separately from the vehicle closed-loop driving control device 20, the corresponding functionalities can in some examples also be combined in one single closed-loop control device. Thus, the complexity of the vehicle 10 is reduced.

In addition, the assembly 12 according to this example also includes a user interface 60, via which notifications for the driver of the vehicle 10 can be output and, on the basis thereof, the driver can effect user inputs. For example, the driver can specify a destination via the user interface 60, which is considered by the algorithm having the path-following function 22.

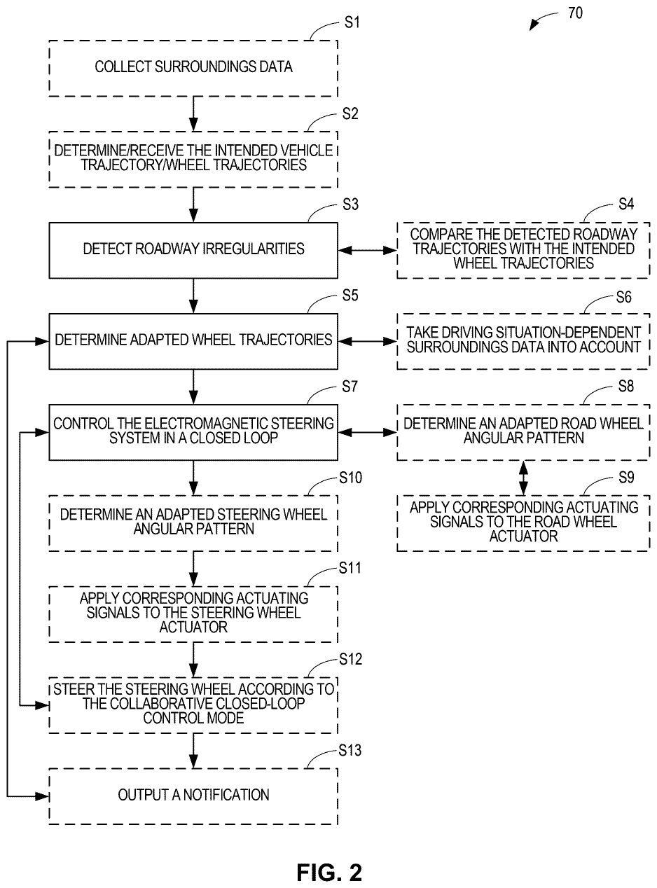

FIG. 2 shows a simplified schematic representation of a method 70 for operating an assembly 12 for a vehicle 10 according to one example. Optional operations are shown as dashed lines. In the optional operation S1 of the method 70, surroundings data of the surroundings of the vehicle 10 are collected by the surroundings sensor 18. The collected surroundings data are transmitted to the closed-loop control device 16 and, in some examples, also to the vehicle closed-loop driving control device 20.

In the subsequent optional operation S2 of the method 70, an intended vehicle trajectory 24 and intended wheel trajectories 52 of road wheels 28 of the vehicle 10 are determined. The optional operation S2 of the method can be carried out by the closed-loop control device 16 or the vehicle closed-loop driving control device 20 depending on the design of the vehicle 10. Provided the vehicle closed-loop driving control device 20 implements the optional operation S2, the vehicle closed-loop driving control device 20 transmits the corresponding intended vehicle trajectory 24 and intended wheel trajectories 52 to the closed-loop control device 16.

A destination to be reached can be in some examples considered when determining the intended vehicle trajectory 24 and the intended wheel trajectories 52. The intended vehicle trajectory 24 can be determined using the algorithm having the path-following function 22. The intended wheel trajectories 52 then result, because the road wheels 28 of the vehicle 10 are rigidly arranged on the vehicle 10.

In some examples, in the operation S2, the surroundings data collected via the surroundings sensor 18 can also be additionally considered. For example, roadway boundaries and/or lanes and/or road users and/or objects can be considered when determining the intended vehicle trajectory 24.

The method 70 then includes the operation S3 in which roadway irregularities 54 are detected using the surroundings sensor 18, which roadway irregularities have a position such that they match at least one intended wheel trajectory 52. The operation S3 can be further implemented using the optional operation S4, in that a position and/or a height profile and/or detected extents of the detected roadway irregularities 54 are compared with the intended wheel trajectories 52. The comparison is in some examples carried out via the closed-loop control device 16. As a result, the closed-loop control device 16 can determine the roadway irregularities 54A, the position and extents of which are such that an interaction with an intended wheel trajectory 52 cannot be ruled out.

Provided such a roadway irregularity 54A is detected in the operation S3, the method 70 includes the subsequent operation S5 in which the closed-loop control device 16 determines adapted wheel trajectories 56 which are oriented and positioned such that they do not match the detected roadway irregularity 54A, but rather diverge therefrom. In other words, guidance of the vehicle 10 is provided based on the adapted wheel trajectories 56 to rule out an interaction with the correspondingly detected roadway irregularity 54A. The adapted wheel trajectories 56 are formed such that their respective course matches the respective course of the originally intended wheel trajectories 52 again after a certain time.

The operation S5 can be in some examples further implemented via the operation S6, in that the closed-loop control device 16 takes driving situation-dependent surroundings data, which are collected by the surroundings sensor 18, into account when determining the adapted wheel trajectories 56. The driving-dependent surroundings data relate, in particular, to other road users and/or objects and/or roadway boundaries and/or lanes. This means that the adapted wheel trajectories 56 are determined via the closed-loop control device 16 in such a way that interactions with other objects and/or road users are prevented. In some examples, the adapted wheel trajectories 56 are also formed in such a way that the vehicle 10 does not leave the intended lane.

If, in the operation S5, an adapted wheel trajectory 56 cannot be determined in such a way that an interaction with a correspondingly detected roadway irregularity 54A can be ruled out, the closed-loop control device 16 can determine the adapted wheel trajectories 56 at least in such a way that the interaction with the detected roadway irregularity 54A is reduced or minimized. Thus, the influence of the detected roadway irregularity 54A on the vehicle 10 can be minimized.

According to the subsequent operation S7 of the method 70, the electromechanical steering system 14 is subsequently controlled in a closed loop by the closed-loop control device 16 in such a way that the road wheels 28 follow the respective adapted wheel trajectories 56. This means that the closed-loop control device 16 outputs at least corresponding actuating signals to the electromechanical steering system 14, so that the desired lateral guidance of the vehicle 10 is ensured. Provided the closed-loop control device 16 also acts as the closed-loop control device of the electromechanical steering system 14, the closed-loop control device 16 can also output corresponding actuating signals itself to the components of the electromechanical steering system 14.

The operation S7 of the method 70 can be further implemented in many ways. For example, the operation S7 can be further implemented using the optional operation S8 such that the closed-loop control device 16 determines at least one adapted road wheel angular pattern for at least one road wheel 28 of the vehicle 10 in such a way that the road wheels 28 follow the respective adapted wheel trajectories 56. This means that the closed-loop control device 16 determines how the road wheels 28 of the vehicle are to be oriented so that the road wheels 28 follow the adapted wheel trajectories 56. Ultimately, the extent to which the road wheels 28 are to be rotated about the respective wheel steering axis is determined, because of which the adapted road wheel angular pattern is defined. In some examples, the adapted road wheel angular pattern deviates from a road wheel angular pattern which corresponds to the (e.g., originally) intended wheel trajectories 52.

As a further optional example, the operation S8 can be further implemented via the optional operation S9, in which the closed-loop control device 16 outputs at least actuating signals to a road wheel actuator 32 in such a way that at least one steerable road wheel 28 of the vehicle 10 is steered so as to follow the adapted road wheel angular pattern. It is thus ensured that the road wheel actuator 32 adapts the orientation of the steerable road wheels 28 in a corresponding manner so that the road wheels 28 undergo a change in the road wheel angle in such a way that this corresponds to the adapted wheel trajectories 56.

The operation S7 can, alternatively or additionally, also be further implemented via the optional operation S10, in which at least one adapted steering wheel angular pattern for the steering wheel 26 of the vehicle 10 is determined via the closed-loop control device 16 in such a way that the adapted steering wheel angular pattern is formed so as to correspond to the adapted wheel trajectories 56. Although the electromechanical steering system 14 enables, in principle, a decoupling of the steering wheel 26 from the steerable road wheels 28, the possibility is created as a result that the components of the electromechanical steering system 14 correspondingly behave in a manner corresponding to one another. As a result, the driver of the vehicle 10 is not surprised by lateral guidance measures that relate exclusively to the road wheels 28. The adapted steering wheel angular pattern is formed to correspond to the adapted wheel trajectories 56, however, and therefore deviates from an (e.g., originally) intended steering wheel angular pattern which is formed to correspond to the (e.g., originally) intended wheel trajectories 52.

In some examples, the optional operation S11 is used to further implement the optional operation S10, in that the closed-loop control device 16 outputs actuating signals to the hand wheel actuator 40 in such a way that the steering wheel 26 is steered so as to follow the adapted steering wheel angular pattern. Thus, it is ensured that the steering wheel 26 is also actually steered according to the adapted wheel trajectories 56.

In some examples, the method 70 can have the operation S12. In such examples, the steering wheel 26 is steered via the closed-loop control device 16 according to a collaborative closed-loop control mode. This means that the steering wheel 26 can be rotated by the hand wheel actuator 40 based on actuating signals of the closed-loop control device 16, although a driver torque can also be additionally applied to the steering wheel 26 by the driver of the vehicle 10. Thus, the application of a driver torque is not suppressed. This results in the driver of the vehicle 10 being able to exert influence on the lateral guidance of the vehicle 10 despite the method 70. As a result, the steering wheel angular pattern deviates from the adapted steering wheel angular pattern from the optional operation S10.

The steering wheel sensor 44 is used to detect the steering wheel angle and/or the steering wheel speed and to transmit the detected measured values to the closed-loop control device 16. The closed-loop control device 16 then outputs corresponding actuating signals to the road wheel actuator 32, which orients the steerable road wheels 28 of the vehicle 10 in a corresponding manner. This can result in the vehicle 10 being moved along in such a way that the road wheels 28 do not follow the adapted wheel trajectories 56. An additional degree of freedom is thus created, however, in that the driver can evade the roadway irregularities 54 based on their own steering inputs. In the optional operation S12, a torque can be applied to the steering wheel 26 by the hand wheel actuator 40 in such a way that the driver is driven at least in the direction of a steering wheel angle and/or a steering wheel speed which has a course that is formed so as to correspond to the adapted wheel trajectories 56.

If the steering wheel 26 is controlled in a closed loop according to the collaborative closed-loop control mode and the driver of the vehicle 10 applies a driver torque to the steering wheel 26, the steering wheel 26 can be controlled in a closed loop via the closed-loop control device 16 in such a way that the steering wheel angle and/or the steering wheel speed is again formed so as to correspond to the adapted wheel trajectories 56 when the driver stops applying an additional driver torque to the steering wheel 26. This means that the driver can control the steering wheel 26 in a closed loop using a driver torque in a manner diverging from the adapted wheel trajectories 56. Provided the actuation is terminated or reduced by the driver, however, the steering wheel 26 is again returned, according to the adapted wheel trajectories 56, in the direction of the steering wheel angle defined as a result and/or of the steering wheel speed defined as a result. Thus, a seamless transition of the collaborative closed-loop control mode of the steering wheel 26 by the driver, on the one hand, and by the autonomous closed-loop control on the basis of the closed-loop control mode 16 and/or on the basis of the vehicle closed-loop driving control device 20, on the other hand, is made possible.

The operation S7 can also be further implemented via the optional operation S13 of the method 70, in which the closed-loop control device 16 initiates the output of a notification to the driver of the vehicle 10, provided adapted wheel trajectories 56 are determined via the closed-loop control device 16. Thus, the driver of the vehicle 10 can be informed about the effect, via the method 70, on the lateral guidance of the vehicle 10. To output the notification, for example, the user interface 60 can be used. As an optional development, the output of a notification can also be prevented by using a corresponding user input. The user input can also be carried out, for example, via the user interface 60.

Example instructions and/or operations of FIG. 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

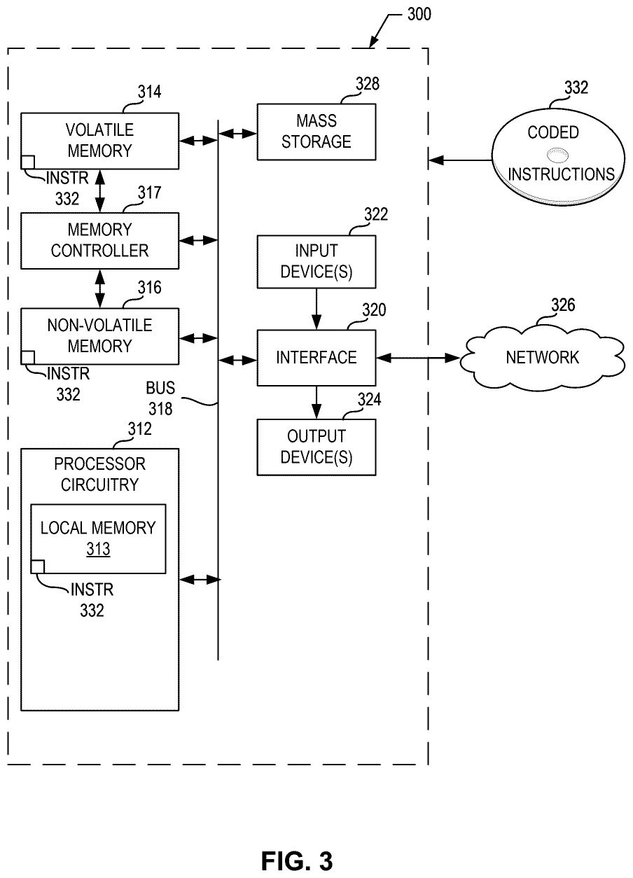

FIG. 3 is a block diagram of an example programmable circuitry platform 300 structured to execute and/or instantiate the example machine-readable instructions and/or the example operations of FIG. [Flowcharts] to implement examples disclosed herein. The programmable circuitry platform 300 can be, for example, a control device, an electronic control unit (ECU), a self-learning machine (e.g., a neural network), or any other type of computing and/or electronic device.

The programmable circuitry platform 300 of the illustrated example includes programmable circuitry 312. The programmable circuitry 312 of the illustrated example is hardware. For example, the programmable circuitry 312 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 312 may be implemented by one or more semiconductor based (e.g., silicon based) devices.

The programmable circuitry 312 of the illustrated example includes a local memory 313 (e.g., a cache, registers, etc.). The programmable circuitry 312 of the illustrated example is in communication with main memory 314, 316, which includes a volatile memory 314 and a non-volatile memory 316, by a bus 318. The volatile memory 314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 316 may be implemented by flash memory and/or any other desired type of memory device. Access to the main memory 314, 316 of the illustrated example is controlled by a memory controller 317. In some examples, the memory controller 317 may be implemented by one or more integrated circuits, logic circuits, microcontrollers from any desired family or manufacturer, or any other type of circuitry to manage the flow of data going to and from the main memory 314, 316.

The programmable circuitry platform 300 of the illustrated example also includes interface circuitry 320. The interface circuitry 320 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 322 are connected to the interface circuitry 320. The input device(s) 322 permit(s) a user (e.g., a human user, a machine user, etc.) to enter data and/or commands into the programmable circuitry 312. The input device(s) 322 can be implemented by, for example, an audio sensor, a microphone, a camera (still or video), a button, a touchscreen, and/or a voice recognition system.

One or more output devices 324 are also connected to the interface circuitry 320 of the illustrated example. The output device(s) 324 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 320 of the illustrated example, thus, typically includes a graphics driver card, a graphics driver chip, and/or graphics processor circuitry such as a GPU.

The interface circuitry 320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 300 of the illustrated example also includes one or more mass storage discs or devices 328 to store firmware, software, and/or data. Examples of such mass storage discs or devices 328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 332, which may be implemented by the machine-readable instructions of FIG. [Flowcharts], may be stored in the mass storage device 328, in the volatile memory 314, in the non-volatile memory 316, and/or on at least one non-transitory computer readable storage medium such as a CD or DVD which may be removable.

Overall, an assembly 12 and a method 70 are thus provided, which make it possible to detect roadway irregularities 54, in an automated way, for which an interaction with the vehicle 10 would occur. As a countermeasure, adapted wheel trajectories 56 are determined to prevent the interaction with the roadway irregularities 54. This results in increased driving comfort for the driver of the vehicle 10 and in a longer service life of the assembly 12, of the electromechanical steering system 14, and of the vehicle 10 overall, because the vehicle 10 is subjected to fewer abrupt external actions of force.

Specific examples disclosed here use circuits (for example, one or more circuits) to implement standards, protocols, methods, or technologies disclosed here, to functionally couple two or more components, to generate information, to process information, to analyze information, to generate signals, to encode/decode signals, to convert signals, to transmit and/or receive signals, to control other devices in a closed loop, etc. Circuits of any type can be used.

In one example, a circuit such as the closed-loop control device includes inter alia one or more data processing devices such as a processor (for example, a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics or combinations thereof. In one example, the circuit includes hardware circuit implementations (for example, implementations in analog circuits, implementations in digital circuits and the like, and combinations thereof).

In one example, circuits include combinations of circuits and computer program products with software or firmware instructions, which are stored on one or more computer-readable memories and interact to prompt a device to carry out one or more of the protocols, methods, or technologies described herein. In one example, the circuitry includes circuits such as, for example, microprocessors or parts of microprocessors, which require software, firmware, and the like to operate. In one example, the circuits include one or more processors or parts thereof and the associated software, firmware, hardware, and the like.

In this disclosure, reference may be made to amounts and numbers. Unless expressly indicated, such amounts and numbers are not to be considered as limiting, but rather as examples of the possible amounts or numbers in connection with the disclosure. In this context, the term “plurality” may also be used in the disclosure to refer to an amount or a number. In this context, the term “plurality” means any number that is greater than one, for example, two, three, four, five, etc. The terms “approximately,” “close to,” etc., mean plus or minus 5% of the indicated value.

Although the disclosure has been presented and described with reference to one or more example(s), a person skilled in the art, after having read and understood this description and the accompanying drawings, will be able to make equivalent changes and modifications.

Example methods and apparatus to operate a vehicle are disclosed herein. Further examples and combinations thereof include the following:
Example 1 includes a vehicle comprising a surroundings sensor to provide first data, and a controller configured to detect a position of a roadway irregularity using the first data, determine that an intended road wheel trajectory of at least one road wheel of the vehicle matches the position of the roadway irregularity, and determine an updated wheel trajectory for the at least one road wheel based on the position of the roadway irregularity.
Example 2 includes the vehicle of example 1, wherein the controller is to cause a road wheel actuator of the vehicle to steer the vehicle along the updated wheel trajectory.
Example 3 includes the apparatus of any one or more of examples 1-2, wherein the updated wheel trajectory is determined based on a type of the roadway irregularity corresponding to at least one of a bump, a pothole, a curb, or an object.
Example 4 includes the apparatus of any one or more of examples 1-3, wherein the updated wheel trajectory is determined based on a height of the roadway irregularity.
Example 5 includes the vehicle of example 4, wherein the height of the roadway irregularity is at least one of a negative height or a positive height with respect to a height profile of a part of a roadway surrounding the roadway irregularity.
Example 6 includes the apparatus of any one or more of examples 1-5, wherein the updated wheel trajectory is determined based on a dimension of a roadway on which the vehicle is travelling.
Example 7 includes the apparatus of any one or more of examples 1-6, wherein the updated wheel trajectory is determined based on other vehicles travelling along a roadway on which the roadway irregularity is located.
Example 8 includes the apparatus of any one or more of examples 1-7, wherein the controller is to generate a notification to a user interface of the vehicle based on the updated wheel trajectory.
Example 9 includes a non-transitory machine readable storage medium comprising instructions which cause programmable circuitry to detect a position of a roadway irregularity using first data from a surroundings sensor of a vehicle, determine that an intended road wheel trajectory of at least one road wheel of the vehicle matches the position of the roadway irregularity, and determine an updated wheel trajectory for the at least one road wheel based on the position of the roadway irregularity.
Example 10 includes the non-transitory machine readable storage medium of example 9, wherein the programmable circuitry is to cause a road wheel actuator of the vehicle to steer the vehicle along the updated wheel trajectory.
Example 11 includes the apparatus of any one or more of examples 9-10, wherein the updated wheel trajectory is determined based on a type of the roadway irregularity corresponding to at least one of a bump, a pothole, a curb, or an object.
Example 12 includes the apparatus of any one or more of examples 9-11, wherein the updated wheel trajectory is determined based on a height of the roadway irregularity.
Example 13 includes the non-transitory machine readable storage medium of example 12, wherein the height of the roadway irregularity is at least one of a negative height or a positive height with respect to a height profile of a part of a roadway surrounding the roadway irregularity.
Example 14 includes the apparatus of any one or more of examples 9-13, wherein the updated wheel trajectory is determined based on a dimension of a roadway on which the vehicle is travelling.
Example 15 includes the apparatus of any one or more of examples 9-14, wherein the updated wheel trajectory is determined based on other vehicles travelling along a roadway on which the roadway irregularity is located.
Example 16 includes the apparatus of any one or more of examples 9-15, wherein the programmable circuitry is to generate a notification to a user interface of the vehicle based on the updated wheel trajectory.
Example 17 includes a method comprising detecting a position of a roadway irregularity using first data from a surroundings sensor of a vehicle, determining that an intended road wheel trajectory of at least one road wheel of the vehicle matches the position of the roadway irregularity, and determining an updated wheel trajectory for the at least one road wheel based on the position of the roadway irregularity.
Example 18 includes the method of example 17, further including causing a road wheel actuator of the vehicle to steer the vehicle along the updated wheel trajectory.
Example 19 includes the method of any one or more of examples 17-18, wherein the updated wheel trajectory is determined based on a type of the roadway irregularity corresponding to at least one of a bump, a pothole, a curb, or an object.
Example includes the method of any one or more of examples 17-19, wherein the updated wheel trajectory is determined based on a height of the roadway irregularity.

What is claimed is:

1. A vehicle comprising:
a surroundings sensor to provide first data; and
a controller configured to:
detect a position of a roadway irregularity using the first data;
determine that an intended road wheel trajectory of at least one road wheel of the vehicle matches the position of the roadway irregularity; and
determine an updated wheel trajectory for the at least one road wheel based on the position of the roadway irregularity.

2. The vehicle of claim 1, wherein the controller is to cause a road wheel actuator of the vehicle to steer the vehicle along the updated wheel trajectory.

3. The vehicle of claim 1, wherein the updated wheel trajectory is determined based on a type of the roadway irregularity corresponding to at least one of a bump, a pothole, a curb, or an object.

4. The vehicle of claim 1, wherein the updated wheel trajectory is determined based on a height of the roadway irregularity.

5. The vehicle of claim 4, wherein the height of the roadway irregularity is at least one of a negative height or a positive height with respect to a height profile of a part of a roadway surrounding the roadway irregularity.

6. The vehicle of claim 1, wherein the updated wheel trajectory is determined based on a dimension of a roadway on which the vehicle is travelling.

7. The vehicle of claim 1, wherein the updated wheel trajectory is determined based on other vehicles travelling along a roadway on which the roadway irregularity is located.

8. The vehicle of claim 1, wherein the controller is to generate a notification to a user interface of the vehicle based on the updated wheel trajectory.

9. A non-transitory machine readable storage medium comprising instructions which cause programmable circuitry to:
detect a position of a roadway irregularity using first data from a surroundings sensor of a vehicle;
determine that an intended road wheel trajectory of at least one road wheel of the vehicle matches the position of the roadway irregularity; and
determine an updated wheel trajectory for the at least one road wheel based on the position of the roadway irregularity.

10. The non-transitory machine readable storage medium of claim 9, wherein the programmable circuitry is to cause a road wheel actuator of the vehicle to steer the vehicle along the updated wheel trajectory.

11. The non-transitory machine readable storage medium of claim 9, wherein the updated wheel trajectory is determined based on a type of the roadway irregularity corresponding to at least one of a bump, a pothole, a curb, or an object.

12. The non-transitory machine readable storage medium of claim 9, wherein the updated wheel trajectory is determined based on a height of the roadway irregularity.

13. The non-transitory machine readable storage medium of claim 12, wherein the height of the roadway irregularity is at least one of a negative height or a positive height with respect to a height profile of a part of a roadway surrounding the roadway irregularity.

14. The non-transitory machine readable storage medium of claim 9, wherein the updated wheel trajectory is determined based on a dimension of a roadway on which the vehicle is travelling.

15. The non-transitory machine readable storage medium of claim 9, wherein the updated wheel trajectory is determined based on other vehicles travelling along a roadway on which the roadway irregularity is located.

16. The non-transitory machine readable storage medium of claim 9, wherein the programmable circuitry is to generate a notification to a user interface of the vehicle based on the updated wheel trajectory.

17. A method comprising:
detecting a position of a roadway irregularity using first data from a surroundings sensor of a vehicle;
determining that an intended road wheel trajectory of at least one road wheel of the vehicle matches the position of the roadway irregularity; and
determining an updated wheel trajectory for the at least one road wheel based on the position of the roadway irregularity.

18. The method of claim 17, further including causing a road wheel actuator of the vehicle to steer the vehicle along the updated wheel trajectory.

19. The method of claim 17, wherein the updated wheel trajectory is determined based on a type of the roadway irregularity corresponding to at least one of a bump, a pothole, a curb, or an object.

20. The method of claim 17, wherein the updated wheel trajectory is determined based on a height of the roadway irregularity.
